(19) United States
(12) Patent Application Publication
(10) Pub. No.: US 2014/0360090 A1
(43) Pub. Date: Dec. 11, 2014

(54) FLOATING FISHING ACCESSORY WITH POSITIONAL STABILIZATION

(71) Applicant: Scott B. Nickolas, Clearwater, FL (US)

(72) Inventor: Scott Bradley NICKOLAS, Clearwater, FL (US)

(21) Appl. No.: 14/300,863

(22) Filed: Jun. 10, 2014

Related U.S. Application Data
(60) Provisional application No. 61/833,401, filed on Jun. 10, 2013.

(51) Int. Cl. A01K 97/06; A01K 97/10; A01K 97/05

(52) U.S. Cl. CPC A01K 97/06; A01K 97/05; A01K 97/10
USPC 43/55; 29/428

(57) ABSTRACT

Herein disclosed is a unique floating fishing accessory comprised of a rigid frame having commonly available tubular closed cell foam pool toys affixed thereto for floatation and further comprising a netted or perforated fish storage enclosure that doubles as a sea anchor so as to resist movement of the accessory under windy conditions.

### PRIORITY

This application claims the benefit of U.S. Provisional Application Ser. No. 61/833,401, filed Jun. 10, 2013, the entire contents of which are incorporated by reference herein.

### FIELD OF THE INVENTION

The present invention relates generally to the field of floating fishing accessories and is more particularly directed to a floating fishing accessory for shallow water anglers that is both rugged and easy to maintain and that further includes a mechanism for limiting the drift of the accessory when subjected to wind forces.

### BACKGROUND OF THE INVENTION

Fishing in shallow coastal waters is a popular sport. This type of fishing, often called “flats fishing”, takes place in water that may range from less than a foot to three or more feet in depth. This type of fishing is challenging because fish in such shallow waters are easily alerted to the angler's presence and accordingly flee the area. Thus, stealth is required, with the angler either wading or using a shallow-draft watercraft such as a kayak to approach the fish. Because the angler is either wading or in a small watercraft, he must either carry all of the required bait and tackle on his person, or have a type of floating fishing accessory to transport the necessary bait, tackle and associated items, along with optional items such as beverages and/or snacks. Such floating fishing accessories for storing tackle and other items while fishing in shallow water by wading or using a kayak or similar manually powered shallow watercraft are well known in the art. For example:

Garcia in U.S. Pat. No. 4,638,593 describes “a generally boat-shaped fishing accessory” having various compartments for live bait, food and other items. The hull of the accessory, however, is constructed from molded plastic that, if damaged during use or transport, is quite difficult to repair. Furthermore, while the hull is provided with a “hull stabilization” mechanism in the form of two small fins that extend from the bow portion to the rear live-bait tank portion, such a mechanism would have little effect in positionally stabilizing the accessory against shifts due to wind.

Ruggles in U.S. Pat. No. 4,996,790 describes a “floating bait bucket with a catamaran external hull that is perforated to allow for the flow of water therethrough”. Floatation is provided by a “foamed in place layer of closed cell polyurethane foam which serves not only to provide a positive floatation mechanism but also to insulate a refreshment container”. However, as with Garcia, the Ruggles hull is formed of ABS plastic that would be difficult to repair if damaged. Also, the bottom of the external hull is formed of flat surfaces that would readily allow the accessory to drift when subjected to even moderate winds.

Gillming in U.S. Pat. No. 5,402,596 describes a “floating holder for a wading fisherman's accessories” that has “a floating platform having a flat bottom and a plurality of fishing rod supports”. The main structural member is “preferably made of a plastic outer shell 46 covering a foam core 48”. As with previous devices, repair of cracks or perforations in the Gillming device is difficult and the flat bottom of the device allows for free drift even when subjected to moderate wind.

Benavidez in U.S. Pat. No. 6,014,833 describes a “floating fisherman's accessory which is fabricated of Styrofoam” that “includes several openings which extend into the water including a large opening for placement of the 5 gallon bucket”. Because the bucket protrudes well below the lower surface of the device, the accessory has “a pair of metal skids” that extend “along a bottom length on each side of the device allowing the device to be pulled across terrain without damaging the live bait bucket”. While the perforated five-gallon bucket protruding into the water would provide some resistance to movement due to wind, the large distance that it protrudes below the water will prove problematic when fishing in very shallow water or crossing sandbars at low tide. In such conditions, while the “skids” would allow the device to be dragged behind the fisherman without damage to or interference from the protruding bucket, the device would be cumbersome and unacceptably difficult to move. In addition, because the structure is made of foam, it is easy to break and quite difficult to repair.

Wallace in U.S. Pat. No. 6,269,587 describes a “surf fishing caddy that includes a float body”, an integral cooler, and other compartments for storing fishing tackle and other items, along with openings for holding fishing rods. The float body also contains “a fish retaining bag” which is positioned in an opening in the float body, with the lower portion of the bag extending freely into the water below the float. The float body is formed of a rigid closed-cell foam, a material which may be easily damaged and is difficult to repair. Additionally, since the live fish bag has no rigid structural members and the bottom of the accessory is flat, the accessory would offer little resistance to positional shift of the accessory due to wind.

Wilhelm in U.S. Pat. No. 7,222,743 describes a “floating apparatus for supporting fishing accessories”. The apparatus has a central perforated base member surrounded by a plurality of arcuate floats having arcuate conduits generally centrally formed therein. The floats are made from a Styrofoam™ material covered by canvas for increased durability. The floats are connected by a resilient cord that passes through the central conduits of the floats to form an annular assembly. Critically absent from the Wilhelm apparatus is a means for positional stabilization when subjected to wind forces. Also, while the construction of the floats makes them quite rugged and resistant to damage, if a float is damaged or degrades due to exposure to salt water, it is necessary to get another replacement float from the manufacturer since the float must be of the proper diameter and formed to the proper arcuate shape with the proper arcuate conduit. Such constraints limit the maintainability of the device.

In view of the limitations of the presently available alternatives, there continues to be a need for a rugged, easily maintained accessory for anglers fishing in shallow water, particularly one that provides storage for common fishing tackle and associated items, cool storage for food and beverage items, and a means for positional stabilization when subjected to wind forces.

### SUMMARY OF THE INVENTION

Further to the above-noted need in the art, it is accordingly an objective of the present invention to provide a floating fishing accessory that provides storage for tackle and other fishing paraphernalia.

It is also an objective of the present invention to provide a floating fishing accessory that may be towed on a tether, either behind a wading angler or behind a small manually powered watercraft, such as a rowboat, canoe or kayak.

It is also an objective of the present invention to provide a floating fishing accessory that includes receptacles configured to receive the butt ends of fishing rods for storage, transport, or stabilization when fishing.

It is also an objective of the present invention to provide a floating fishing accessory that includes a planar horizontal working surface for baiting hooks, temporary placement of opened beverages, or temporary storage of tackle.

It is further an objective of the present invention to provide a floating fishing accessory that includes a secure mounting location for a commercial cooler.

It is additionally an objective of the present invention to provide a floating fishing accessory that is easy to repair and maintain using commonly available materials and items.

It is additionally an objective of the present invention to provide a floating fishing accessory that includes a secure enclosure for the storage of live fish.

It is finally an objective of the present invention to provide a floating fishing accessory that includes a mechanism to stabilize the position of the accessory when in use in open water, more particularly a means or mechanism to resist movement of the accessory due to wind forces.

These and other goals and objectives may be accomplished by the invention herein disclosed. However, it will be understood by those skilled in the art that one or more aspects of this invention can meet certain of the above objectives, while one or more other aspects can meet certain other objectives. Each objective may not apply equally, in all its respects, to every aspect of this invention. As such, the preceding objectives and foregoing description should be viewed in the alternative with respect to any one aspect of this invention.

The present invention arose from the discovery of an easily maintainable floating fishing accessory having a rigid frame member that is given buoyancy through the affixation of commonly available expanded polymeric foam structures to the frame. Accordingly, a damaged floatation member may be easily replaced with materials commonly available at low cost. According to the principles of the instant invention, the floating fishing accessory is preferably provided with a rigid frame. In a particularly preferred embodiment, the frame is formed of square aluminum tubing members joined by welding or other suitable water-resistant joining mechanism. In other embodiments, stainless steel tubing is used. In still other embodiments, the frame is constructed of polymeric members such as, for instance, PVC pipe.

As noted above, buoyancy is provided by expanded polymeric foam structures, more particularly tubular expanded polyethylene (EPE) members that are widely sold as pool toys and are commonly referred to as “swim noodles” or by similar names. Illustrative examples of such commercially available floating structures include the Big Boss Four Inch Water Noodle available through the Gladon Company (Oak Creek, Wis.) and the Super Wacky Noodle available through Lifoam, Inc. (Hunt Valley, Md.). These tubular EPE members are commonly sold in lengths that range between four and five feet, in outer diameters that generally range from 1.5 to 6 inches, and with a tubular central lumen that ranges between 0.5 and 2.0 inches in diameter. In a preferred embodiment, the EPE members have an outside diameter of approximately three to four inches and an inner lumen diameter of approximately 1.2 inches.

The EPE material from which the floatation members are formed is flexible and resilient and yet has a high tensile strength and a high resistance to tearing or cutting. The high resistance to salt water absorption of the EPE material also makes it well suited to use in salt water and thus of high suited to use as a sea- or bay-fishing accessory.

Both the rigid frame and the tubular floatation members can be readily scaled to a wide range of desirable sizes. To wit, the tubular floatation members is preferably cut to lengths that correspond to the lengths of the respective sides of the rigid frame members, which are generally on the order of 12 to 48, more preferably 24 to 36 inches. In terms of preferred affixation, a radial axial cut is made through a single wall along the entire length of the flotation member, the cut extending from the central lumen to the outer surface. The slit in the floatation member is then spread sufficiently to allow its placement on the desired frame member. While the resistance to deformation and rebounding elasticity inherent to the material affords some constraint to the floatation member, it is preferably to further constrain the material so as to prevent spreading of the slit and dislocation of the floatation member from the frame member. In a preferred embodiment, such further constraint is supplied by one or more circumferential polymeric bands commonly referred to as “wire wraps” or “tie wraps” or “cable ties”. In other embodiments, a circumferential elastic element may be used. In still other embodiments, a suitable water-resistant adhesive may be applied to the walls of the axial slit in the floatation element so that the walls are permanently joined after positioning of the floatation element on the frame element. However, the present invention is not limited to any particular constraining method of mechanism; as such, all methods of constraining the floatation element to the frame element are considered to fall within the scope of the present invention.

While the floatation elements are inherently resistant to damage, if a floatation element is damaged it can easily be removed from the frame and replaced by a new equivalent floatation element, i.e., a standard commercially available tubular foam elements sold as water play toys, and affixed to a frame member in the manner previously herein described. This allows for easy repair maintenance of the floating fishing accessory using only commonly available materials, a feature not found in previous fishing accessories.

The floating fishing accessory of the present invention may have one or more planar horizontal deck portions that allow for the temporary storage of fishing tackle and other items including, for instance, beverages and snacks. The accessory may further be provided with one or more tubular structures configured to receive the butt end of fishing rods that are arranged to the frame in a relatively vertical orientation so as to allow temporary storage of such fishing rods during transport or while fishing, for instance, while baiting a hook or attaching a fishing lure to the end of the fishing line. The floating fishing accessory of the present invention may also have a receiving area formed in its upper structure, wherein the receiving area is configured to accept a cooler for the storage of food, beverages, or frozen baits and to ensure that the cooler remains in the location when the accessory is subjected to wave action.

The floating fishing accessory of the present invention further include in its frame an annular structure to which a flexible fish containment enclosure formed of netting or perforated fabric may be attached, with the open upper end of the enclosure being affixed to the annular structure, and the closed bottom end of the enclosure having positioned therein a rigid ring or a perforated plate of approximately the same size as the upper annular structure. As discussed in greater detail hereinbelow, the present inventor has discovered that such a flexible enclosure, with its associated bottom ring acts much like a sea anchor in that it resists the flow of water through the structure so as to provide resistance to movement of the fishing accessory. Accordingly, the flexible structure, contemplated for use in the storage of live fish or live bait, also provides a significant degree of positional stability to the accessory, allowing it to resist movement when subjected to wind forces. In this manner, the fisherman may position the accessory behind him or in another location in which the accessory will not limit his activity, and the accessory will remain in that location, or only drift slowly from that position when subjected to wind forces. If the fisherman is in a kayak or other small watercraft, the accessory will remain behind the vessel during travel, and will largely maintain that position when the angler stops to fish. Additionally, because the fish storage enclosure is not a rigid structure, it is possible for the angler to pull the accessory through very shallow water without interference from the storage enclosure. In a preferred embodiment, the annular structure is round and the bottom ring or plate is round. In other preferred embodiments, the rigid ring or perforated plate is metallic. In yet other embodiments, the rigid ring or plate is formed from a polymeric material.

Due to its unique construction, including a simple rigid frame and commonly available tubular floatation elements, the floating fishing accessory of the present invention may be easily maintained and repaired. Furthermore, due to its unique flexible containment structure, with its associated annular top and bottom rings or plates, the floating fishing accessory of the present invention has unique positional stability.

The objectives, aspects and features of the invention discussed herein above will become more fully apparent when the following detailed description is read in conjunction with the accompanying figures and/or examples. However, it is to be understood that both the foregoing summary of the invention and the following detailed description are of preferred embodiments and not restrictive of the invention or other alternate embodiments of the invention. Various modifications and applications may occur to those who are skilled in the art, without departing from the spirit and the scope of the invention, as described by the appended claims. Likewise, other objectives, features, benefits and advantages of the present invention will be apparent from this summary and certain embodiments described below, and will be readily apparent to those skilled in the art having knowledge of electrode design. Such objectives, features, benefits and advantages apparent from the above in conjunction with the accompanying examples, data, figures and all reasonable inferences to be drawn there-from are specifically incorporated herein.

### BRIEF DESCRIPTION OF THE DRAWINGS

Various aspects and applications of the present invention will become apparent to the skilled artisan upon consideration of the brief description of the figures and the detailed description of the present invention and its preferred embodiments that follows:

FIG. 1 is a plan view of an illustrative rigid frame suitable for use in the construction of a floating fishing accessory in accordance with the principles of the present invention.

FIG. 2 is a side elevational view of the objects of FIG. 1.

FIG. 3 is a perspective view of the objects of FIG. 1.

FIG. 4 is a perspective view of an illustrative floatation member, suitably slit for use in the construction of a floating fishing accessory in accordance with the principles of the present invention.

FIG. 5 is a side elevational view of the objects of FIG. 4.

FIG. 6 is an axial end view of the objects of FIG. 4.

FIG. 7 is a plan view of the structural elements of FIGS. 1 and 4 assembled together to form an illustrative embodiment of a floating fishing accessory in accordance with the present invention.

FIG. 8 is a side elevational view of the objects of FIG. 7.

FIG. 9 is a perspective view of the objects of FIG. 7.

FIG. 10 is a perspective view of an illustrative embodiment of a floating fishing accessory constructed in accordance with the principles of the present invention that includes the flexible fish containment structure-cum-positional stabilizer (406) unique to the present invention.

FIG. 11 is a side elevational view of the objects of FIG. 10.

### DETAILED DESCRIPTION OF THE PREFERRED EMBODIMENTS

The present invention is directed to a unique floating fishing accessory for the shallow-water angler that is not only easy to use and maintain but the further resists movement under windy conditions. A floating fishing accessory constructed in accordance with the principles of the instant invention has two primary structural elements, namely a rigid frame constructed from a rigid tubing material, and a plurality of discrete floatation members formed from resilient closed-cell tubular foam extrusions widely sold as swimming toys. To construct floatation members suitable for use in the context of the present invention, a commercially available length of tubular foam extrusion is cut to the desired length and then an axial cut is made along the length that extends from the outer surface of the tubular extrusion only just to the middle, the inner lumen of the tube. In this manner, the tubular extrusion may be easily deformed and mounted to an element of the rigid frame and, due to rebounding elasticity of the foam material, thereby secured in place. In a preferred embodiment, polymeric binding devices commonly referred to as “cable ties” are employed and circumferentially secured about the tubular element to prevent its unmounting from the frame element. Construction of the fishing accessory of the instant invention is best understood through the figures and associated text following. However, before the present materials and methods are described, it is to be understood that the present invention is not limited to the particular materials, methodologies or protocols herein described, as these may vary in accordance with routine experimentation and optimization. It is also to be understood that the terminology used in the description is for the purpose of describing the particular versions or embodiments only, and is not intended to limit the scope of the present invention which will be limited only by the appended claims.

### Elements of the Present Invention:

Unless otherwise defined, all technical and scientific terms used herein have the same meaning as commonly understood by one of ordinary skill in the art to which this invention belongs. In case of conflict, the present specification, including following definitions, will control.

The words “a”, “an”, and “the” as used herein mean “at least one” unless otherwise specifically indicated.

In the context of the present invention, the term “proximal” is used to refer to an end, portion, or direction that is situated closest to or points to the user. In contrast, the term “distal” is used to refer to that end, portion, or direction that is situated farthest away or points away from the user.

In the context of the present invention, the terms “axial” and “longitudinal” are used to refer to travel along a long axis of a body, i.e., a lengthwise direction or dimension. For example, the present invention makes reference to an “axial” slit formed in one side of the elongate tubular foam structure that makes up the floatation members of the present invention.

In contrast, the term “lateral” is used herein to refer to travel perpendicular or transverse to a long axis of the body, i.e., a side-to-side direction or dimension. For example, the present invention makes reference to a rigid frame having an optionally rectangular configuration, comprised of at least two opposing longitudinal sides and at least two opposing lateral sides.

In the context of the present invention, the term “radial” is used to refer to the direction that extends outward from the center of a circular or tubular structure or inward from the circumference inward along a radius. For example, the aforementioned “axial” slit formed in one side of the elongate tubular foam structure extends radially from the circumference inward to the center lumen of the tubular foam structure of the present invention.

In the context of the present invention, the term “annular” is used to refer to a ring-like part, band or shape such as arises between the area of two concentric circles. For example, the present invention makes reference to the bottom annular component of the novel fish storage enclosure of the present invention.

In the context of the present invention, the terms “tube”, “tubing”, and “tubular” collectively refer to components that have the form or shape of a hollow, preferably elongate cylinder or lumened passage. For example, the present invention makes reference to the rigid “tubing” that make up the rigid frame of the present invention as well “tubular” foam structures that form the pontoon-like floatation members of the floating fishing accessory of the present invention.

In the context of the present invention, the terms “frame” and “frame component” are used interchangeably to refer to the rigid structure that constitutes the circumference or perimeter of the floating fishing accessory of the present invention.

In the context of the present invention, the term “polygon” is used to refer to a closed planar figure having at least three line segments (i.e., straight sides) and associated angles, and typically four, five or more straight sides and angles. For example, the present invention makes reference to a “polygonal frame component”, more particularly a rectangular or square frame component. However, alternate non-polygonal configurations such as circles and ellipses are also contemplated.

In the context of the present invention, a polygon may be “regular”, i.e., comprised of all equal sides and all equal angles, or “irregular”, wherein the sides and angles are not all equal. A non-limiting example of an irregular polygon contemplated by the present invention is a trapezoid; a non-limiting example of regular polygon contemplated by the present invention is a rectangle or square.

In the context of the present invention, the term “rigid” is used to refer to a material that is physically inflexible or stiff, more particularly that is resistant to bending when subject those forces common to its intended use. For example, the present invention makes reference to a “rigid frame” that is sufficiently inflexible so as to maintain its shape in the presence of wave, wind, and water forces common to sea and bay fishing as well as the ground and drag forces common to shallow water fishing. In the context of the present invention, the rigid frame is preferably fabricated from aluminum, stainless steel or PVC tubing.

In contrast, the term “flexible” is used herein to refer to a pliable or compliant material that may easily be bent or flexed without breaking For example, the present invention makes reference to a “floatation member” that may be easily cut, deformed and flexed so as to facilitate mounting about the longitudinal and lateral components of the aforementioned rigid frame. In the context of the present invention, the flexible floatation members are preferably fabricated from an expanded polymeric foam and more particularly comprise a tubular expanded polyethylene (EPE) member widely available and commonly referred to as “swim noodles”. However, other materials having a similarly high buoyancy and good resistance to salt water absorption and degradation may be used.

Such tubular EPE “swim noodle” members are commonly sold in lengths that range between four and five feet, with outer diameters generally ranging from 1.5 to 6.0 inches and inner diameters that ranges between 0.5 and 2.0 inches. In a preferred embodiment, the EPE member has an outside diameter of approximately three to four inches and an inner lumen diameter of approximately 1.2 inches.

### Illustrative Embodiments of the Present Invention

Although any methods and materials similar or equivalent to those described herein can be used in the practice or testing of embodiments of the present invention, the preferred methods, devices, and materials are now described in greater detail by reference to the exemplary embodiments. However, the following examples only illustrate aspects of the invention and in no way are intended to limit the scope of the present invention. As such, embodiments similar or equivalent to those described herein can be used in the practice or testing of the present invention.

### EXAMPLES

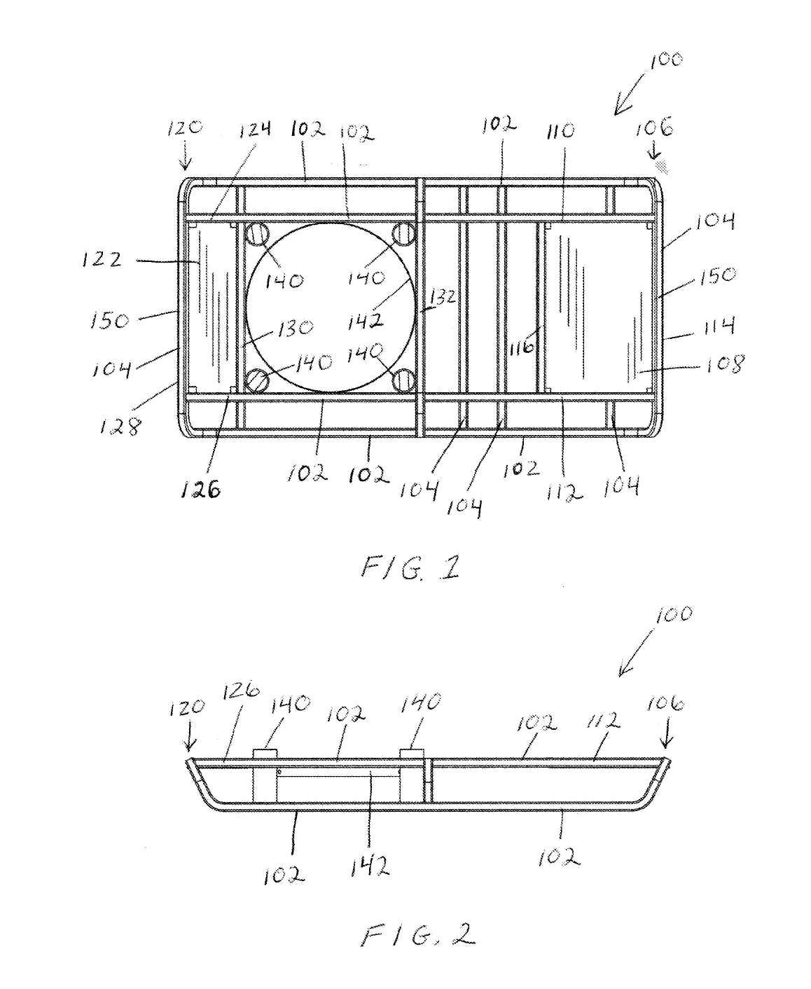

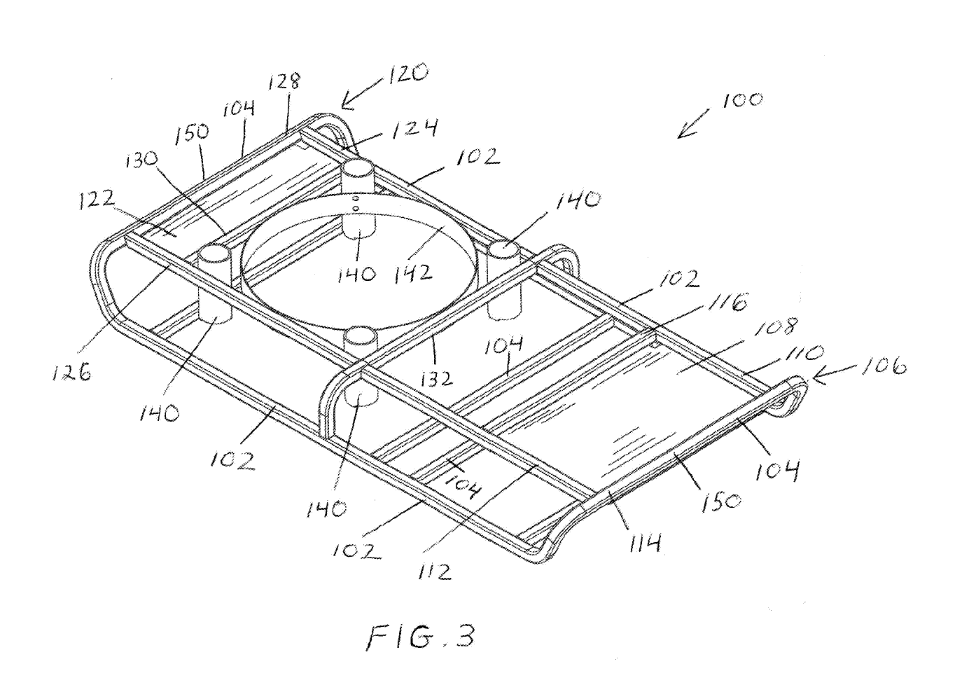

Referring to FIGS. 1 through 3 depicting a frame for a fishing accessory of the present invention, frame 100 is formed of longitudinally extending elements 102 joined by laterally extending elements 104. In a preferred embodiment, the frame is formed from square aluminum tubing. In other embodiments, stainless steel tubing is used. In these embodiments, the elements of the frame are preferably joined by welding. In a preferred embodiment, tungsten inert gas (TIG) welding is used. In other embodiments wherein metallic tubing is used to form the frame, metal inert gas (MIG) welding or another joining method are used. In still other embodiments, polymeric tubing such as, for instance, PVC pipe is used and the elements are joined by means of standard pipe fittings and/or solvent bonding.

Frame 100 has a first end 106 having formed adjacent thereto a planar horizontal deck member 108 bound by longitudinally extending elements 110 and 112, and by laterally extending elements 114 and 116. Similarly, frame 100 has a second end 120 having formed adjacent thereto a planar horizontal deck member 122 bound by longitudinally extending elements 124 and 126 and by laterally extending elements 128 and 130. Laterally extending members 130 and 132, and longitudinally extending members 124 and 126 together define a square region of the frame in the four corners of which are mounted tubular elements 140 which are configured to receive the butt end of a fishing rod to allow temporary storage of the fishing rod therein. Also within the region defined by elements 124, 126, 130 and 132 and tangentially in contact with the elements, circular tubular element 142 is configured for the attachment of a fish containment enclosure formed from net or perforated fabric. Centrally located on laterally extending members 114 and 128, holes 150 provide a means for mounting a tether that may be attached to the stern of a watercraft, to the belt of a wading fisherman, or to an anchoring device.

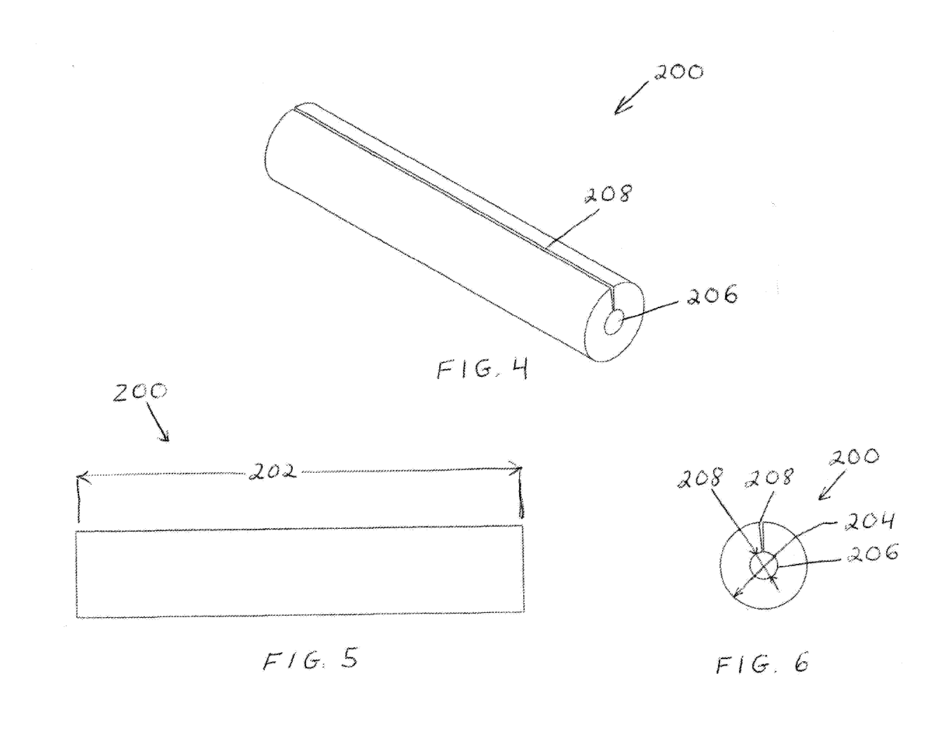

FIGS. 4 through 6 depict a floatation element 200 ready for mounting to frame 100. Element 200 has a length 202 suitable for mounting to a longitudinally extending element 102 or laterally extending element 104 of frame 100. Element 200 has a centrally located lumen 206 and a longitudinal slit 208 formed in a wall of extrusion 200. Extrusion 200 is formed from an extrusion of flexible resilient closed cell foam material such as, for instance expanded polyethylene (EPE) or a similar material with high buoyancy and good resistance to salt water absorption and degradation. In a preferred embodiment, the foam extrusion is a widely available pool toy commonly referred to as a “noodle” of some form. In a preferred embodiment, the diameter 204 of floatation element 200 is between 1.5 and six inches, preferably between two and five inches, and more preferably between three and 4.5 inches. Lumen 208 has a diameter between 0.5 and two inches, and more preferably between 0.75 and 1.5 inches.

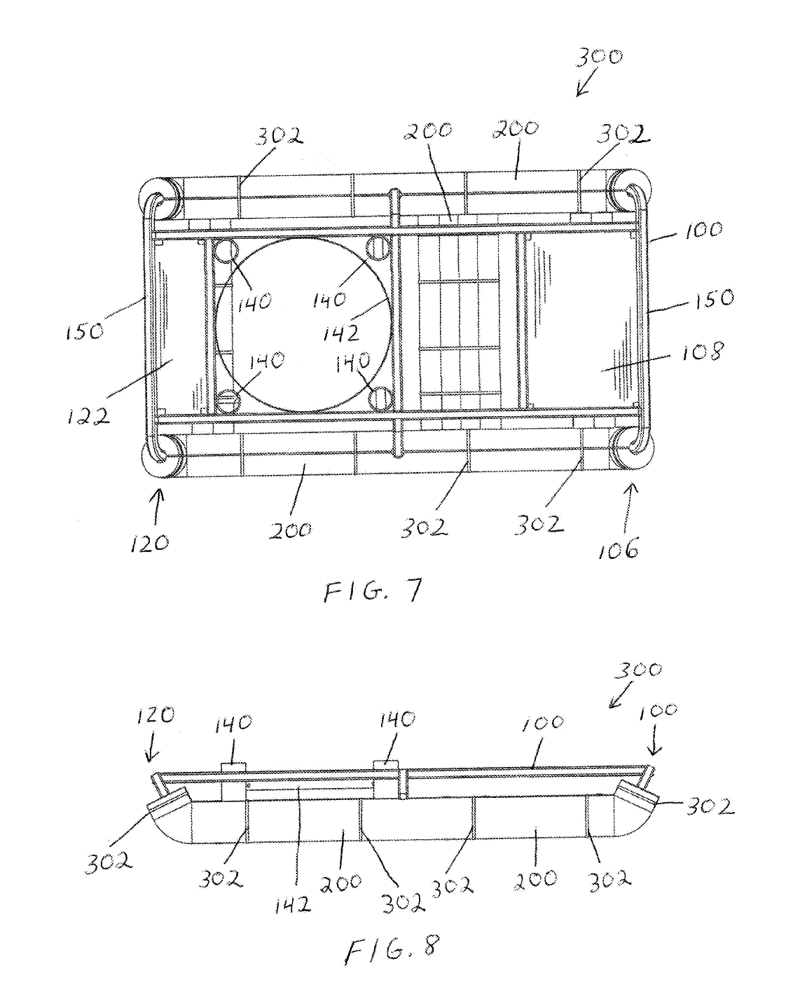

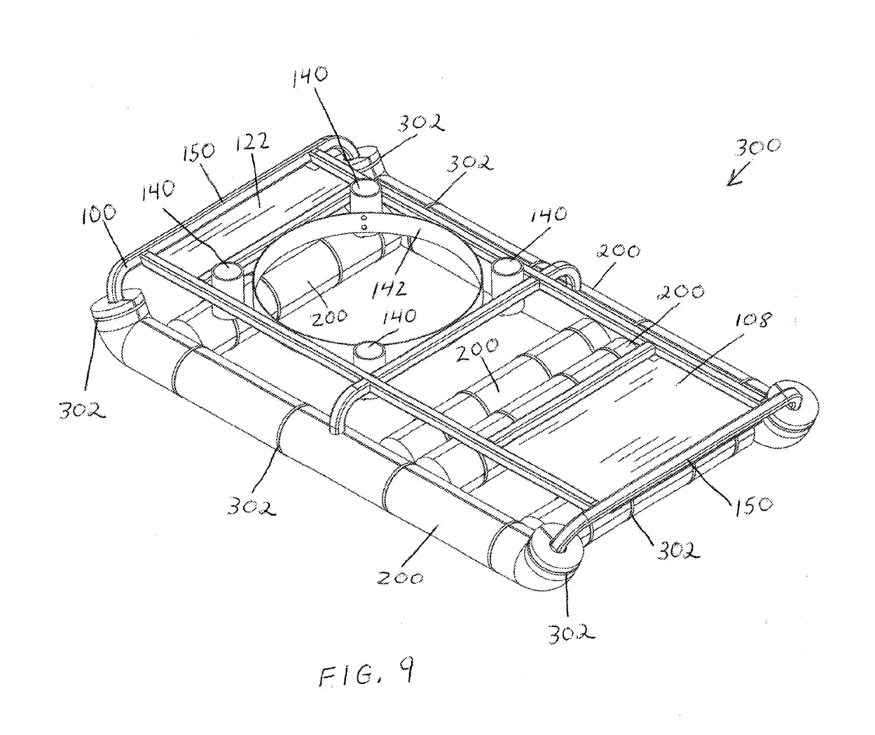

FIGS. 7 through 9 depict a fishing accessory platform 300 formed in accordance with the principles of the present invention. Floatation elements 200 are circumferentially confined by wire ties 302 so as to affix floatation elements 200 to frame 100.

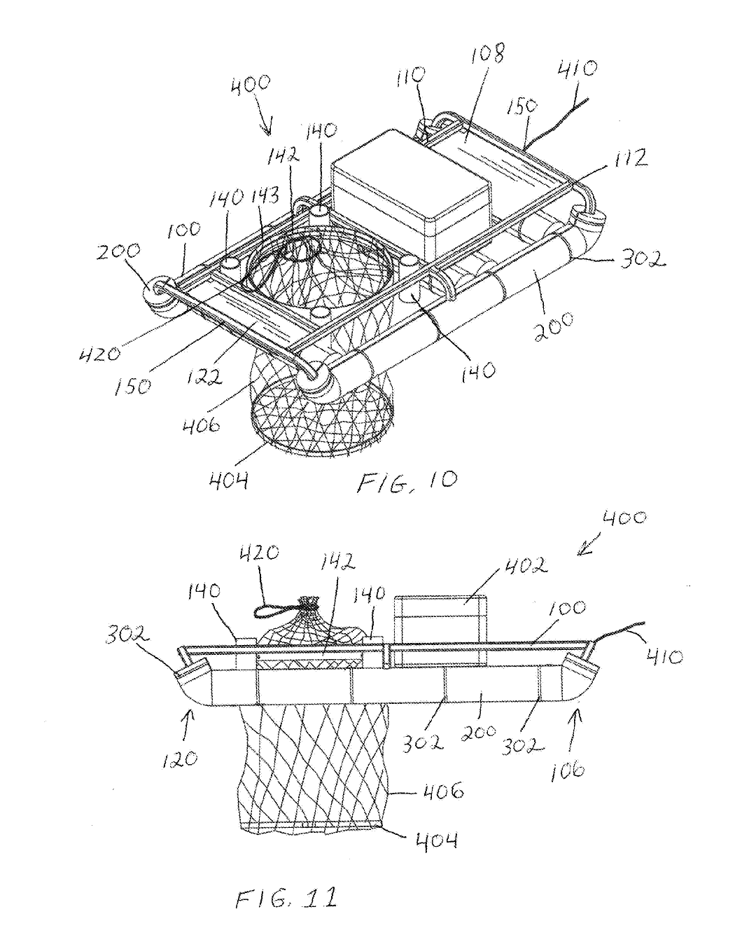

FIGS. 10 and 11 depict fishing accessory 400 formed in accordance with the principles of the present invention. In addition to platform 300, accessory 400 has attached to tubular element 142 by ring element 143 and cable ties (not shown) a fish containment enclosure 406 having contained at its bottom end ring 404 and closure at its top end by drawstring 420. In a preferred embodiment, ring 404 is made from a made from a metallic material, typically aluminum or stainless steel and has sufficient weight to ensure that enclosure 406 is extended to maximal depth. In an alternate embodiment, ring 404 is replaced by a circular plate which may optionally have perforations formed therein, the plate having more weight than ring 404. Accessory 400 has attached to first end 106 of frame 100 tether 410 that may be attached to the stern of a small watercraft, or to the belt of a wading angler. Cool box 402 is positioned between longitudinally extending members 110 and 112, and laterally extending members 116 and 132 (FIG. 1), cool box 402 being confined to prevent movement when accessory 400 is used in rough water and subjected to wave action.

Fish containment enclosure 406 functions in the manner of a sea anchor, resisting the flow of water therethrough so as to provide a stabilizing effect with resists movement of accessory 400 when fishing under windy conditions. Because the containment enclosure is formed from net or perforated fabric, accessory 400 may be used in very shallow water in which a rigid enclosure would unacceptably drag on the bottom.

### INDUSTRIAL APPLICABILITY

The floating fishing accessory described herein is of a simple, easily repairable and maintainable and low cost construction. Yet by offering such features in combination with elements that provide resistance to undue movement under windy conditions, the present invention fills a lingering need not served by currently available alternatives.

All patents and publications mentioned herein are incorporated by reference in their entirety. Nothing herein is to be construed as an admission that the invention is not entitled to antedate such disclosure by virtue of prior invention.

While the invention has been described in detail and with reference to specific embodiments thereof, it is to be understood that the foregoing description is exemplary and explanatory in nature and is intended to illustrate the invention and its preferred embodiments. Through routine experimentation, one skilled in the art will readily recognize that various changes and modifications can be made therein without departing from the spirit and scope of the invention. Such other advantages and features will become apparent from the claims filed hereafter, with the scope of such claims to be determined by their reasonable equivalents, as would be understood by those skilled in the art. Thus, the invention is defined not by the above description, but by the following claims and their equivalents.

What is claimed:

1. A floating fishing accessory configured for shallow water angling, said accessory comprising:
a. a frame component having an upper user-facing surface and a lower water-facing surface, wherein said lower surface is comprised of first and second relatively parallel lengths of rigid longitudinal tubing and at least a first and second relatively parallel length of rigid lateral tubing, wherein each of said rigid tubing lengths comprises a proximal end, a distal end, and an elongate axial portion that extends therebetween, further wherein the respective proximal ends of said first and second lateral tubing lengths are assembled to said first longitudinal tubing length, the first near the proximal end and the second near the distal end of said first longitudinal tubing length, and the respective distal ends of said first and second lateral tubing lengths are assembled to said second longitudinal tubing length, the first near the proximal end and the second near the distal end of said second longitudinal tubing length, whereby said assembled rigid tubing lengths define a planar perimeter;
b. a plurality of elongate floatation members fabricated from an expanded polymeric foam, wherein each of said plurality of floatation members has a proximal, a distal end and an elongate axial portion and tubular central lumen that extend between said ends; and
c. a cylindrical fish containment enclosure that acts as positional stability mechanism, wherein said cylindrical enclosure comprises a rigid base in the form of a circular plate or annular ring, an axially extending peripheral surface comprised of porous netting or perforated fabric, and a rigid top surface assembled to the upper surface of said frame component, wherein said rigid top surface further includes a closure mechanism;
wherein each of said plurality of floatation members is assembled about each of said rigid tubing lengths such that each of said rigid tubing lengths is positioned within the central lumen of a respective floatation member assembled thereover.

2. The floating fishing accessory of claim 1, wherein said lower surface further comprises a third and optionally a fourth length of rigid lateral tubing, wherein the respective proximal ends of said third and an optional fourth lateral tubing lengths are assembled to said first longitudinal tubing length and the respective distal ends of said third and an optional fourth lateral tubing lengths are assembled to said second longitudinal tubing length, wherein said third and an optional fourth lateral tubing lengths are disposed in between said first and second lateral tubing lengths in a relatively parallel fashion.

3. The floating fishing accessory of claim 2, wherein said third and optional fourth lateral tubing lengths also have a respective floatation member assembled thereabout, whereby each of said third and fourth tubing lengths is positioned within the central lumen of its respective floatation member assembled thereover.

4. The floating fishing accessory of claim 3, wherein said third and optional fourth lateral tubing lengths and their associated floatation members together define a rectangular recessed region configured to securely receive a storage cooler.

5. The floating fishing accessory of claim 1, wherein said rigid tubing lengths are fabricated from a material selected from among aluminum, stainless steel, and PVC.

6. The floating fishing accessory of claim 1, wherein said rigid tubing lengths are fabricated from a metal material and are joined together by means of welding.

7. The floating fishing accessory of claim 1, wherein said rigid tubing lengths are fabricated from a polymeric material and are joined together by means of pipe fittings or solvent bonding.

8. The floating fishing accessory of claim 1, wherein said planar lower surface has a rectangular or square perimeter.

9. The floating fishing accessory of claim 1, wherein said expanded polymeric foam comprises expanded polyethylene (EPE).

10. The floating fishing accessory of claim 9, wherein said EPE material is flexible and resilient yet possesses a high tensile strength and a high resistance to tearing or cutting and well as a high resistance to salt water absorption.

11. The floating fishing accessory of claim 1, wherein each of said plurality of linear tubular floatation members has an outer diameter of between 2 and 5 inches and an inner diameter of between 0.75 and 1.5 inches.

12. The floating fishing accessory of claim 1, wherein each of said plurality of floatation members is provided with a radial axial slit that extends along the entire length of the floatation member, from its central lumen to its outer surface, wherein said radial axial slit allows each of floatation members to deform and fit over each of said rigid tubing lengths.

13. The floating fishing accessory of claim 12, wherein each of said radially axially slit floatation members is further secured about each of said rigid tubing lengths by means of one or more wire wraps, tie wraps, elastomeric bands or cable ties.

14. The floating fishing accessory of claim 12, wherein, once each floatation member is assembled about each rigid tubing lengths, each of said radial axial slits is subsequently sealed with a suitable marine adhesive suitable water-resistant adhesive.

15. The floating fishing accessory of claim 1 further comprising a planar horizontal deck portion assembled to the upper surface of said frame component.

16. The floating fishing accessory of claim 1 further comprising one or more tubular receptacles configured to receive the butt end of fishing rods, wherein said tubular receptacles are arranged to the upper surface of said frame component in a relatively vertical orientation.

17. The floating fishing accessory of claim 1, wherein said closure mechanism of said rigid top surface of said cylindrical fish containment enclosure comprises a drawstring.

18. The floating fishing accessory of claim 1, wherein the upper surface of said frame component is provided with one or more tow holes or tow loops that are configured to receive one end of a towing tether, the other end of which is configured for attachment to the stern of a watercraft, the belt of a wading fisherman, or an anchoring device.

19. A method of assembling the floating fishing accessory configured for shallow water angling set forth in claim 1, said method comprising the steps of:
a. assembling said frame component by joining said first and second relatively parallel lengths of rigid longitudinal tubing to said at least a first and second relatively parallel length of rigid lateral tubing by welding, marine adhesive, or solvent bonding or via a plurality of pipe fittings;
b. assembling the rigid upper surface of said cylindrical fish containment to the upper surface of said frame component;
c. providing a plurality of elongate floatation members sized to fit over the plurality of rigid tubing lengths;
d. providing each of said plurality of floatation members with a radial axial slit that extends along the entire length of the floatation member, from its central lumen to its outer surface;
e. fitting each of said axially radially slit floatation members about each of said plurality of rigid tubing lengths such that each of said rigid tubing lengths is positioned within the central lumen of the respective floatation member assembled thereover.

20. The method of claim 19, further comprising the step of securing each of said axially radially slit floatation members about each of said plurality of rigid tubing lengths using one or more wire wraps, tie wraps, elastomeric bands or cable ties.
